(19) United States
(12) Patent Application Publication
(10) Pub. No.: US 2013/0206528 A1
(43) Pub. Date: Aug. 15, 2013

(54) DEVICE FOR CONNECTING A VEHICLE WITH A SOCKET

(71) Applicants: Norbert Enning, Denkendorf (DE); Michael Korte, Ingolstadt (DE); Jörg Michael, Ingolstadt (DE)

(72) Inventors: Norbert Enning, Denkendorf (DE); Michael Korte, Ingolstadt (DE); Jörg Michael, Ingolstadt (DE)

(73) Assignee: Audi AG, Ingolstadt (DE)

(21) Appl. No.: 13/879,291

(22) PCT Filed: Sep. 30, 2011
(86) PCT No.: PCT/EP11/04885

§ 371 Date: Apr. 12, 2013

(30) Foreign Application Priority Data
Oct. 13, 2010 (DE) 10 2010 048 385.5

(51) Int. Cl. H02G 11/02

(52) U.S. Cl. CPC H02G 11/02
USPC 191/12.2 R

(57) ABSTRACT

The invention relates to a device for connecting a vehicle operated by electrical current to a socket of a low-voltage alternating-current network, said device comprising a charging cable provided with a plug that fits the socket. The charging cable comprising the plug is arranged in a recess beneath a region of the bonnet of the vehicle that is true to the windscreen of the vehicle. The charging cable is at least indirectly connected to the vehicle in a fixed manner.

The invention relates to a device for connecting a vehicle which is operated by electric current with a socket of a low-voltage AC power grid of the type defined in the preamble of claim 1.

Due to the relatively high CO₂ emission of conventional internal combustion engines which operate according to the Diesel or Otto principle, and due to the diminishing oil reserves, a recent trend towards hybrid vehicles and vehicles exclusively operated by electric current has emerged. Such motor vehicles, referred to as electric vehicles have an electric motor and a rechargeable battery which supplies the electric motor with an electric current and can be recharged in different ways. On one hand, it is possible to recharge the electric vehicles with direct current at so-called electric fuel stations by means of a quick charging with direct current which requires the use of charging cables with very great diameter, due to the high currents. Another possibility for charging these electric vehicles is to connect the electric vehicles to conventional sockets of a low-voltage AC power grid as they can be found in every household but also in many garages or carports. Although charging the batteries at such “normal” sockets takes significantly longer than the above-mentioned quick charging, the downtime is usually sufficient to completely charge the battery via the low-voltage AC power grid when the vehicle is parked overnight in a garage or a carport.

EP 053-7065 B1 describes a possibility to connect an electromotively operated vehicle with a socket. Here, the charging connector is fixed in a housing which is arranged movably on the chassis of the motor vehicle. The housing can be closed by the rear license plate of the motor vehicle.

A disadvantage of this solution is however in particular the fact that for connecting the charging connector with the socket an additional charging cable has to be carried along for which additional space has to be provided within the motor vehicle. A further disadvantage of this known solution is that the arrangement of the charging connector in the area of the rear license plate provides relatively poor accessibility to the charging connector, in particular because a bumper has to be provided in this area for safety reasons whose construction is made more complicated by the presence of the charging connector.

With regard to the state-of-the-art relating to rechargeable batteries and motor scooters with sockets reference is made to EP 0608841 B1 and EP 06486341.

It is an object of the present invention to provide a device for connecting a vehicle operated by electric current with a socket, which device can be handled very easily by a user of the vehicle and at the same time provides protection of the charging cable.

According to the invention, this object is solved by the features set forth in claim 1.

By accommodating the charging cable and the plug below the region of the bonnet of the vehicle that is associated with the windshield, the charging cable and the plug are protected against contamination and can nevertheless be easily retrieved to connect the vehicle with the socket. The handling of the device according to the invention is thus very easy and allows for a quick connection of the vehicle with the power grid.

Further, according to the invention, the charging cable is at least indirectly fixedly connected with the vehicle and thus is always carried along with the vehicle and cannot get lost so that the battery of the vehicle, provided that an socket is available, can always be charged.

A protection of the charging cable and the socket against contamination or damage by external influences results when in a very advantageous refinement of the invention, the recess can be closed by of the lid.

This protection can be further enhanced when the lid is locked.

When, in a further advantageous embodiment of the invention the lid has at least one sealing device, the charging cable and the plug are very efficiently protected against entering of water.

In order to ensure sufficient and appropriate accommodation of the charging cable inside the motor vehicle and at the same time ensure that the charging cable can always be retrieved from the storage location below the bonnet, an advantageous embodiment of the invention can provide that the charging cable is arranged on a windup unit which is at least indirectly connected with the motor vehicle, and can be wound up by means of the windup unit.

As an alternative, it may also be provided that the charging cable is arranged in a cylindrical receiving element. Accommodating the charging cable in such a cylindrical reception element allows storing the charging cable in a region which can be easily accessed and is at the same time protected against contaminations. A further advantage of such a cylindrical receiving element is that it can be stored at many different sites of the vehicle and thus does not interfere with the design of the vehicle. This storage further provides very easy and quick handling.

When the charging cable is configured as spiral cable, the charging cable can be converted from its stored condition inside the motor vehicle into its operating condition in which the plug is plugged into the socket and vise versa, from its operating condition converted into its stored condition. A particular advantage is that such a spiral cable due to its inherent elasticity can be converted into its stored state without application of force or special motions of the operating person, however at the same time external influences, such as wetness, dirt or the like do not limit utilization of the charging cable.

Further advantageous embodiments and refinements of the invention are set forth in the remaining sub claims. In the following, exemplary embodiments of the invention are schematically shown by way of the drawing.

It is shown in:

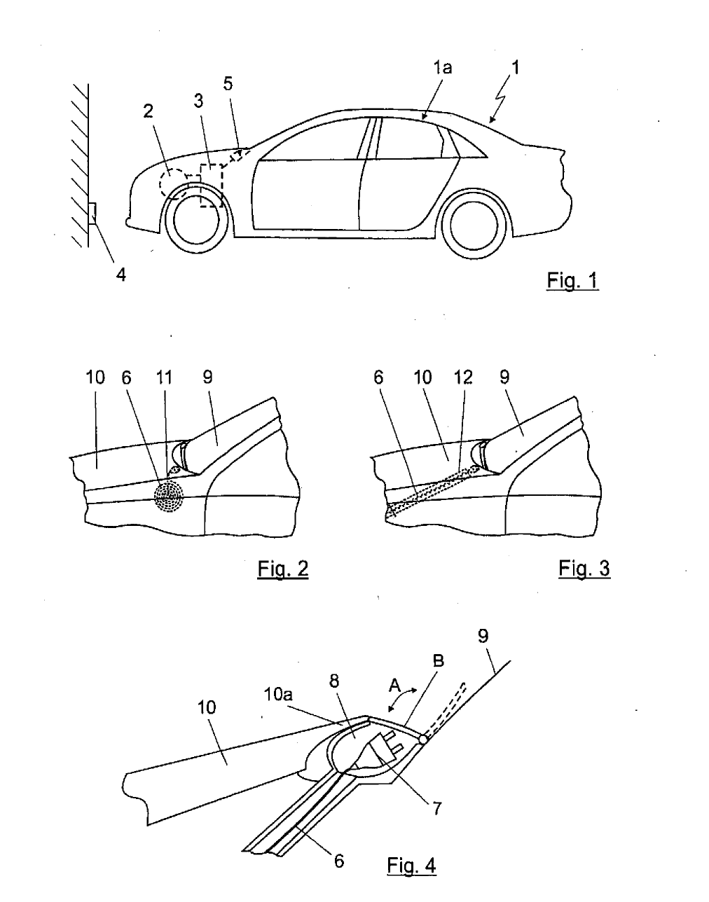

FIG. 1 a vehicle equipped with a device according to the invention;

FIG. 2 a section through a first embodiment of the device according to the invention;

FIG. 3 a section through a second embodiment of the device according to the invention; and

FIG. 4 a section through a third embodiment of the device according to the invention.

FIG. 1 shows a vehicle 1 operated by electric current, with a vehicle body 1a. For this, the vehicle 1 has an electric motor 2 outlined very schematically, and a rechargeable battery 3, which serves for supplying the electric motor 2 with electric current. In order to charge the battery 3, the battery can be connected with an socket 4 of a not shown low-voltage AC power grid. The socket 4 is of the kind as it is used in households or public buildings in the respective country to which the vehicle 1 is shipped. In most countries, the low-voltage AC power grid has a voltage of 230 V, when a one-phase AC current is used. In some other countries for example in the USA, Canada, Mexico and some northern states of South America, the of the AC voltage of the power grid is 120 V. In the Federal Republic of Germany, socket 4 is for example configured as protective contact-socket or Schuko-socket. For connecting the vehicle 1 to the socket 4, a device 5 is used which has a charging cable 6 which in turn has a plug which fits the socket 4. The plug 7 can also be configured differently depending on the country for which the vehicle 1 is intended. Of course, adapters can also be used.

According to the embodiment of the device 5 shown in FIG. 2, the charging cable 6 is arranged in a recess 8 which can be seen well in the enlargement according to FIG. 4, below the region 10a of a bonnet 10 of the vehicle 1 which bonnet 10 is oriented towards the windshield 9. In other words, plug 7 with the charging cable 6 attached thereto is arranged in a step between the bonnet 10 and the windshield 9 of the vehicle 9.

In the embodiment shown in FIG. 2, the charging cable 6 is arranged on a windup device 11 which is at least indirectly connected with the vehicle 1, and by means of the winding device lithe charging cable 6 can be wound up into a coil. The windup device 11 can be configured so that by lightly pulling on the charging cable 6 in the retrieving direction and subsequently releasing the pulling force, the charging cable 6 is automatically wound up. Of course, the windup device 11 can also have a drive motor or the like.

According to the embodiment shown in FIG. 3, the charging cable 6 is arranged in a cylindrical receiving element 12, wherein the charging cable 6 is preferably configured as spiral cable. Such a spiral cable can be converted from a relatively short length recognizable in FIG. 3, to a significantly extended length by corresponding pulling. This allows also bridging greater distances between the charging cable 6 and the socket 4, wherein the charging cable 6 still only requires a small space inside the vehicle 1.

Both embodiments according to FIGS. 2 and 3 have in common, that the charging cable 6 is at least indirectly fixedly connected with the vehicle 1 via the windup device 11 or the cylindrical receiving element 12. In the case of the cylindrical receiving element 12, such a connection of the charging cable 6 to the vehicle 1 can be implemented in that the cylindrical receiving element 12 is rigidly connected with the vehicle 1 and the charging cable 6 is fixedly connected on its end which is opposite the plug 7 with the cylindrical receiving element 12.

As can be seen from the more detailed representation of FIG. 4, the device 5 can have a lid 13 by means of which the recess 8 can be closed. The lid 13 can be moved according to the arrow “A” between a closed position and an open position indicated by the dashed line. In its closed position, the lid 13 can be locked with a not further shown device.

The lid 13 also has a not shown sealing device which prevents water, dirt and the like from entering into recess 8. Such a sealing device preferably extends around the entire lid 13. In the case that water nevertheless enters the recess 8 for example when the lid is not closed, the recess 8 can have a not shown water draining opening. When a cylindrical receiving element 12 is present this water drainage opening can be located at the bottom side of the receiving element 12.

In order to ensure a secure closing of the lid 13, the lid 13 can be provided with a mechanism in a not shown manner, which mechanism causes the closing of the lid 13 when inserting the plug 7 into the recess 8. For example, this can be realized in that the plug 7 has to be inserted into a not shown guide of the lid 13 so that when inserting the plug 7 further into the recess 8, the lid 13 is automatically moved into its closed position.

Further, in order to ensure a simplified retrieval of the plug 7, the lid 13 can have a mechanism which causes the plug 7 to move out of the recess 8 by a defined distance when opening the lid 13. This mechanism can also be implemented by attaching the plug 7 on the lid 13. These two mechanisms can also be coupled with one another, to offer maximum comfort for the user of the device 5.

1-20. (canceled)

21. A device for connecting a vehicle which is operated by electric current with a socket of a low-voltage AC power grid, comprising:
a recess arranged below a region of a bonnet of the vehicle, said region being oriented towards a windshield of the vehicle;
a lid for closing the recess; and
a charging cable being at least indirectly fixedly connected with the vehicle and having a plug fitting the socket, said charging cable and said plug being arranged in the recess, wherein the lid comprises a mechanism causing movement of the plug out of the recess by a defined distance upon opening of the lid.

22. The device of claim 21, wherein the lid further comprises a mechanism constructed for causing closing of the lid upon insertion of the plug into the recess.

23. A device for connecting a vehicle which is operated by electric current with a socket of a low-voltage AC power grid, comprising:
a recess arranged below a region of a bonnet of the vehicle, said region being oriented towards a windshield of the vehicle, said recess being provided with a lid for closing the recess; and
a charging cable being at least indirectly fixedly connected with the vehicle and having a plug fitting the socket, said charging cable and said plug being arranged in the recess.

24. The device of claim 23, wherein the lid comprises a mechanism causing movement of the plug out of the recess by a defined distance upon opening of the lid.

25. The device of claim 21, wherein the lid is constructed lockable.

26. The device of claim 21, wherein the lid comprises at least one sealing device.

27. The device of claim 21, wherein the recess has a water-draining opening.

28. The device of claim 21, further comprising a windup device for winding up the charging cable into a coil, said windup device being at least indirectly connected with the vehicle, said charging cable being arranged on the windup device.

29. The device of claim 21, further comprising a cylindrical receiving element, wherein the charging cable is arranged in the cylindrical receiving element, wherein the charging cable is constructed as spiral cable.
